(19) United States
(12) Patent Application Publication
(10) Pub. No.: US 2023/0326435 A1
(43) Pub. Date: Oct. 12, 2023

(54) 2D USER INTERFACE FOR A MUSICAL INSTRUMENT FOR PLAYING COMBINED SEQUENCES OF CHORDS AND TUNES, AND COMPUTER-READABLE STORAGE MEDIUM

(71) Applicant: DR. GABRIEL GATZSCHE HOLDING GMBH, Geratal OT Geschwenda (DE)

(72) Inventor: Gabriel Gatzsche, Geratal OT Geschwenda (DE)

(21) Appl. No.: 18/028,113

(22) PCT Filed: Sep. 15, 2021
(86) PCT No.: PCT/EP2021/075330

§ 371 Date: Mar. 23, 2023

(30) Foreign Application Priority Data
Oct. 1, 2020 (DE) 10 2020 125 748.1

(51) Int. Cl. G10H 1/00

(52) U.S. Cl. CPC G10H 1/0008; G10H 2220/161; G10H 2210/571; G10H 2220/096

(57) ABSTRACT

The invention relates to a user interface for a musical instrument, in particular an electronic or virtual musical instrument, for playing combined sequences of chords and tunes, comprising a key matrix (1) having a plurality of zones 111, 121, . . . ; 112, 122, . . . ; 11n, 12n, . . . that can be activated, these zones being arranged in columns and rows, each row of activatable zone 111, 121, . . . ; 112, 122, . . . ; 11n, 12n, . . . forming a region 101, 102, . . . , each region 101, 102, . . . being associated with a basic chord that preferably is a chord of a scale, preferably of a diatonic scale, the chord being specific of the scale, and each zone 111, 121, . . . ; 112, 122, . . . ; 11n, 12n, . . . being associated with a musical tone of the tune, which is preferably a musical tone of the tune of the scale. The user interface is designed to produce, when a zone 111, 121, . . . ; 112, 122, . . . ; 11n, 12n, . . . in a region 101, 102, . . . is activated, a musical tone-producing command in accordance with the activated zone 111, 121, . . . ; 112, 122, . . . ; 11n, 12n, . . . and region 101, 102, . . . , and the musical tone-producing command comprises at least one basic chord note command of a pitch that is contained in the basic chord associated with the activated region 101, 102, . . . and comprises a tune note command the pitch of which corresponds to the musical tone of the tune of the activated zone 111, 121, . . . ; 112, 122, . . . ; 11n, 12n, . . . . The invention also relates to a musical instrument, a method for producing combined sequences of chords and tunes, and a computer-readable storage medium.

The present invention relates to a user interface for a musical instrument according to the subject-matter of claim 1, a musical instrument according to the subject-matter of claim 8, a method for producing combined sequences of chords and tunes according to the subject-matter of claim 10, as well as a computer-readable storage medium according to the claim of claim 13.

Many people would like to be able to play a musical instrument in order to be able to create music alone or with other people. However, learning a musical instrument requires a considerable amount of time and energy. This applies both to learning musical instruments and accompanying instruments. If a musician wishes to play both tunes and chords in combination, he has to resort to instruments such as a piano, which is difficult to learn and expensive to acquire and also has a considerable space requirement.

If a musician wishes to compose his or her own pieces of music or play general chord sequences with a matching tonal melody, theoretical musical knowledge is required, which further increases the learning effort and time consumption.

Attempts have been made in the prior art to overcome the above difficulties in part by providing virtual musical instruments, the acquisition costs of which are lower than traditional instruments, and which can be used on already existing digital devices. Thus, mobile terminals such as smartphones or tablets have rapidly responding touchscreens, which thus provide a useful basis for devising virtual musical instruments. Virtual instruments are thus known which can be installed on a mobile terminal and enable a user to use the touchscreen as an input device for playing a virtual instrument displayed thereon. However, the virtual instruments known in the prior art are also unsuitable for satisfactorily solving all of the problems discussed above. There are in particular no solutions which enable a combined input of chord and tune sequences in a straightforward and intuitive manner.

DE 10 2008 028 328 B4 discloses a device for producing note signals, on which chords can be played with one finger. If the finger is moved in the horizontal direction on an operator unit of the device, different inversions of a selected chord are reproduced. If the finger is moved in the vertical direction, a change is made to another chord. The production of combined chord and tune sequences is not possible with the device.

US 2014/0137721 A1 shows a virtual instrument, on which chord sequences can be played with different inversions. A selection can be made both between different configurations of the selected chord and also between different articulations of the sound. Playing combined chord and tune sequences is once again not possible.

US 2003/0015087 A1 describes a keyboard with a continuous keypad, on which tune sequences can be played with one finger. However, chord or chord sequences cannot be played without musical knowledge.

Against the background set out above, it is the problem of the present invention to create the possibility of producing or playing combined sequences of chords and tunes in as intuitive and simple a manner as possible. In particular, a musically inexperienced user is intended to be able to play melodious and harmonically meaningful chord and tune sequences without having prior knowledge in musical theory or harmonics or without having to learn how to play an instrument. In particular, it should be made possible with the present invention to implement a musical instrument for playing combined chord and tune sequences which is characterised by being highly user-friendly and easy to operate.

The above problem is solved by a user interface according to claim 1, a musical instrument according to claim 8, a method for producing combined sequences of chords and tunes according to claim 10 and a computer-readable storage medium according to claim 13.

In particular, the problem is solved by a user interface for a musical instrument, in particular an electronic or virtual musical instrument, for playing combined chord and tune sequences, comprising a key matrix with a plurality of zones that can be activated, which are arranged in columns and rows, wherein each row of activatable zones forms a region, wherein each region is associated with a basic chord, which is preferably a chord of a scale, preferably a diatonic scale, the chord being specific to the scale, wherein each zone is associated with a musical tone, which is preferably a musical tone of the scale, wherein the user interface is designed to produce, when a zone in a region is activated, a musical tone-producing command corresponding to the activated zone and region, wherein the musical tone-producing command comprises at least one basic chord note command with a pitch which is contained in the basic chord associated with the activated region, and comprises a tune note command, the pitch of which corresponds to the musical tone of the activated zone.

A core idea of the invention consists in the fact that each of the activatable zones is associated both with a basic chord and also with a musical tone of the tune, so that by activating a zone a note command is produced which comprises both chord and also musical tones of the tune. By the (successive) activation of zones, combined chord and tune sequences can thus be produced in a completely intuitive and straightforward manner, without the user having to have knowledge or acquired abilities as with conventional instruments as to how chord and tune tones are produced or which tones have to be played on the instrument for this purpose. Since all zones in a region are associated with the same chord, the basic chord remains fixed and only the musical tone is changed with a successive activation of zones in the same region (i.e. with a playing movement on the key matrix inside the same row). A chord change takes place with a playing movement on the key matrix, in which a played region is left. It is thus possible for the user to determine easily and intuitively when playing a tune the times of the chord changes on the one hand and the times of the tune changes on the other hand. Since only the successive activation of zones is required to produce the combined chord and tune sequences, combined chord and tune sequences can be played with only one finger. An extremely easy use of the user interface is thus achieved.

Each note command comprises the indication of a pitch, which corresponds to the notes to be reproduced. If reference is made to the pitch of a note command, which can be indicated by the indication of the corresponding note, the terms “note” and “note command” are used synonymously within the scope of the present invention.

The basic chords associated with the regions are preferably chords of a scale, the chords being specific to the scale. It can thus be ensured that the basic chords associated with the regions have a strong harmonic relationship with one another, so that chord changes sound harmonic. It is particularly preferable that the scale, which serves as audio material for the basic chords, is a diatonic scale. The basic chords are chords of the diatonic scale, the chords being specific to the scale. A major scale or a (natural) minor scale is preferably used as a diatonic scale. The invention is not however restricted to diatonic scales or the so-called major and minor scales as basic audio material. For example, a chromatic scale, a whole tone scale, a pentatonic, octatonic or other scales can be used as a basis for producing a desired tonality.

The musical tone-producing commands produced when a zone is activated are not limited to any special format. They can be constituted both as control commands for the sound production in a separate sound generator, or can be configured for direct sound production. The musical tone-producing commands can for example be configured in the form of MIDI commands, which can be outputted at a corresponding MIDI sound generator for generating an audio signal. These MIDI commands can be predefined for quicker access and stored on a storage medium. The musical tone-producing commands can also be configured such that they trigger the reproduction of predefined audio wave forms, which are stored in a storage medium and have corresponding pitches, which correspond to the basic chord notes and tune notes associated with the zone. It is also conceivable that the musical tone-producing commands trigger a sound synthesis in a corresponding sound generator or synthesiser. The only important thing is that the musical tone-producing commands are suitable for bringing about the direct or indirect generation of a sound or audio signal, which has the pitch associated with the activated zone, so that the generation of an audio signal with the chord and musical tones of the tune associated with the zone can be triggered by the activation of a zone of the user interface.

The generation of the musical tone-producing commands is likewise not subject to any particular limitation. For example, it is conceivable for the zones to be in a communicative connection with a computing unit such as a microcontroller or similar. When a zone is activated, the user interface produces an activation signal associated with the activated zone. The computing unit receives the activation signal and, based on the association of basic chords and musical tones of the tune with the activated zone, which are stored for example in a suitable memory, produces the musical tone-producing command according to the invention. The computing unit can be constituted as part of the user interface or can be provided separately from the latter and configured for the reception of activation signals. The generation of the musical tone-producing commands can also take place software-based, when the user interface is constituted as a software- or computer-implemented user interface.

If MIDI commands are used as musical tone-producing commands, the user interface can be designed as a component of a MIDI controller, which is also perceived as a musical instrument within the scope of the present invention. In this case, the musical tone-producing commands can be outputted at a MIDI interface, via which a correspondingly configured sound generator can be connected to the MIDI controller, in order to produce or output corresponding audio signals on the basis of the musical tone-producing commands.

The association of the basic chords and musical tones of the tune with the zones and regions can be fixedly predefined or can be adapted during the use of the user interface by corresponding user inputs.

The arrangement of the zones in rows and columns of the key matrix can correspond to an orthogonal grid, in which the zones are arranged beside one another and above one another. It is however also possible for the zones to be arranged partially overlapping, in particular inside a region. The layout of the key matrix is also not limited to a strictly orthogonal arrangement, in which the rows are perpendicular to the columns. The zones of neighbouring regions can also be arranged offset with respect to one another.

The columns and rows of the key matrix can be arranged in such a way that the columns run vertically and the rows horizontally. Alternatively, however, it is also possible to configure the key matrix in such a way that the columns run horizontally and the rows run vertically.

According to a possible embodiment of the invention, the basic chords, which are associated with regions adjacent to one another, have a tonal distance of one fifth from one another. This embodiment is particularly preferred when a diatonic scale, in particular a major scale or a (natural) minor scale, is used as the basic audio material. In this case, the basic chords of regions adjacent to one another have a particularly strong harmonic relationship, so that a particularly catchy and melodious chord change is brought about with a change from one region into an adjacent region, without the user having to have suitable knowledge of harmonics.

According to a further preferred embodiment of the invention, the basic chords, which are associated with regions adjacent to one another, have a tonal distance of one third from one another. For this embodiment, too, it is particularly preferable if a diatonic scale, in particular a major scale or a (natural) minor scale, is used as audio material for the basic chords and the musical tones of the tune. This results in a configuration of the key matrix, in which regions adjacent to one another are associated alternately with major and minor chords with a strong tonal and harmonic relationship. Tonally consistent and pleasing chord changes can be produced with a change from one region into an adjacent region, without the user having to rely on knowledge of harmonics.

Furthermore, it is preferred that musical tones of the tune are associated in ascending pitch with the zones in each region. The musical tones of the tune, which are associated with successive zones in each region, preferably form a scale, preferably a diatonic scale, further preferably a major scale or a (harmonic) minor scale. It is particularly preferable if the musical tones of the tune form the same scale, which also forms the basis of the basic chords. This embodiment enables an intuitively accessible production of tunes within each region, since an ascending or descending tonal movement can be produced by a movement in the corresponding direction inside the region. If the musical tones of the tune are also selected from the same scale, which also serves as audio material for the basic chords, the musical tones of the tune are harmoniously tuned to the basic chords, so that particularly suitable chord and tune sequences can be produced tonally without prior musical knowledge.

The same musical tone of the tune is also preferably associated with the zones in each column of the key matrix. In this embodiment, the musical tone of the tune remains stable and only the basic chord changes when there is a movement along a column of the key matrix. The musical tone of the tune can thus act as a harmonic bridge, which connects the two basic chords to one another. Particularly catchy and at the same time aesthetic and emotionally expressive chord changes can be produced in a straightforward and intuitive manner.

According to a further preferred embodiment of the invention, the pitch of the at least one basic chord note command is selected for each zone, in such a way that it lies below or above the pitch of the musical note-producing command. If the basic chord note command comprises a plurality of notes, it is preferable for the pitch of all the basic chord notes to lie below or above the pitch of the musical tone of the tune.

In principle, the musical tones of the tune can be arranged with regard to their pitch at any position inside the set of notes of the musical tone-producing command. If the pitches of the basic chord notes are fixed in such a way that they lie below the pitch of the musical tone of the tune, the audibility of the musical tone of the tune is improved. In some cases, it may be desirable to use tones of the basic chord as a descant to the musical tone of the tune. In this case, the pitches of the basic chord notes are fixed in such a way that they lie above the pitch of the musical notes of the tune. It is possible that the pitches of all the basic chord notes lie above the pitch of the musical notes of the tune. It is also possible to select the pitches of the basic chord notes in such a way that only a part of the basic chord notes, in particular only one basic chord note, lies above the pitch of the musical tone of the tune. In this case, the basic chord note, the pitch whereof lies above the musical tone of the tune, acts as a descant to the musical tone of the tune, which can be preferable tonally.

For the further tonal emphasis of the musical tones of the tune, a different timbre and/or sound intensity from the tune note command can also be associated with the basic chord note command. If the musical tone-producing commands are implemented as MIDI commands, this can take place for example by the fact that a different MIDI channel and/or a different velocity volume from the musical tone-producing command can be associated with the basic chord note command.

Furthermore, it is preferable that for each zone the pitch of the at least one basic chord note command is selected in such a way that the tonal distance between the musical note-producing command and the closest basic chord note command is greater than a minor second, or alternatively greater than a major second. On the one hand, this improves the perceptibility of the musical tone of the tune and in addition prevents the formation of sound combinations of basic chord tones and musical tones of the tune, which could be perceived as dissonant.

According to a preferred development, the musical tone-producing command includes for each zone a bass note command, which corresponds to one of the tones of the basic chord, preferably the tonic tone of the basic chord, and has a pitch which is lower than the pitch of the remaining note commands. Furthermore, it is preferred that a different timbre and/or sound intensity than the usual note commands is associated with the bass note command. Furthermore, it is preferable that the bass note command is selected such that its pitch does not leave a predefined pitch range. In a further preferred development, the pitch of the bass tone note command does not change with a successive activation of zones inside the same region. By providing the bass tone note command, the sound of the combined chord and tune sequences, which are produced with successive activations of zones, can be improved.

The problem of the invention, furthermore, is solved by a musical instrument, comprising a user interface according to the above description, as well as a sound generator, which is designed, based on the musical tone-producing command, to produce an audio signal for output via an audio output interface.

The features described in the context of the user interface according to the invention can also be applied to the musical instrument according to the invention, and the advantages and effects thus achieved also apply to the musical instrument. With the musical instrument according to the invention, musically inexperienced users are enabled to play combined chord and tune sequences in a simple and intuitive way, without having musical knowledge or having to learn skills on an instrument. The user can produce a combination of chord tones and a musical tone of the tune with just one finger. By the successive activation of zones, therefore, combined sequences of chords and tunes can be produced with just one finger. The musical instrument according to the invention with the user interface according to the invention thus provides the possibility of playing combined chord and tune sequences, which is characterised by a high degree of user-friendliness and ease of use.

The sound generator is not subject to any special restriction and solely has to be adapted to the format of the musical tone-producing commands. If the musical tone-producing commands are configured as MIDI commands, the sound generator can for example be constituted as a computer-implemented software instrument or as a MIDI-sound module. If the musical tone-producing commands are predefined to trigger the reproduction of predefined audio waveforms stored in a storage medium, or to produce sounds by means of sound synthesis, the sound generator can be implemented in a computing unit, for example a microcomputer, of the musical instrument.

The key matrix of the user interface can be constituted in the form of a keyboard comprising mechanically actuatable keys on the musical instrument. In a preferred embodiment, the musical instrument comprises a touch-sensitive touchscreen, on which the key matrix can be displayed and the zones can be activated by touching corresponding display areas of the touchscreen. During playing of the instrument, this enables a particularly easy transition between adjacent zones.

The problem of the invention is also solved by a method for producing combined chord and tune sequences, which is carried out by using a user interface according to the above description, and preferably by using a musical instrument of the type described above. The method comprises the following steps:
provision of a user interface according to the above description
reception of a user input when a zone of the key matrix is activated;
producing a musical tone-producing command corresponding to the activated zone.

The features and advantages which are disclosed in the context of the description of the user interface according to the invention and the musical instrument according to the invention can also be transferred to the method according to the invention. The provision of the user interface can take place by providing a corresponding arrangement of haptic, mechanical keys, or by the display of the key matrix on a touch-sensitive touchscreen. The last two steps of the above method are carried out repeatedly for the production of combined sequences of chords and tunes. Through the association of basic chords and musical tones of the tune with the zones corresponding to the above description of the user interface, a user can produce tonally pleasing sequences of chords and tunes in a straightforward and intuitive manner, whereby he activates different zones of the key matrix successively with just one finger.

The method preferably also includes the following steps:
loading of previously stored audio samples from a storage medium or synthesis of an audio signal corresponding to the produced musical tone-producing command;
outputting of the audio samples or the audio signal via an audio output interface.

Furthermore, it is preferable that the method is constituted as a computer-implemented method, wherein the provision of the user interface comprises the display of the key matrix on a touchscreen. It is thus possible to carry out the method on mobile digital terminals such as smartphones or tablets, which are directly available for many users.

Within the scope of the invention, a computer-readable storage medium is also specified, which contains instructions which cause at least one processor to perform a computer-implemented method according to the above description, when the instructions are carried out by the at least one processor. The user interface described above in the method described above can thus be implemented to produce combined sequences of chords and tunes as a virtual instrument, which can be installed and executed on a mobile terminal such as a smartphone or tablet.

It should also be pointed out at this point that the features and advantages, which have been described above in reference to the user interface according to the invention, the musical instrument according to the invention and the method according to the invention, can also be transferred to the computer-implemented method according to the invention and the computer-readable storage medium according to the invention.

The invention is also described in the following with regard to further features and advantages with the aid of examples of embodiment, which will be explained in greater detail by reference to the figures.

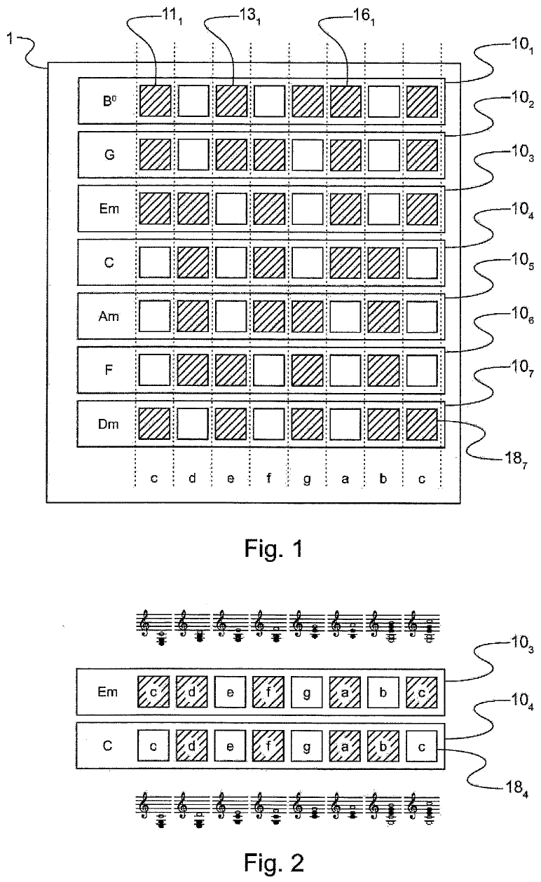

FIG. 1 shows a diagrammatic representation of a key matrix of a user interface according to an example of embodiment of the present invention;

FIG. 2 shows a detail of the key matrix from FIG. 1 with note commands, which can be produced by activating the shown zones.

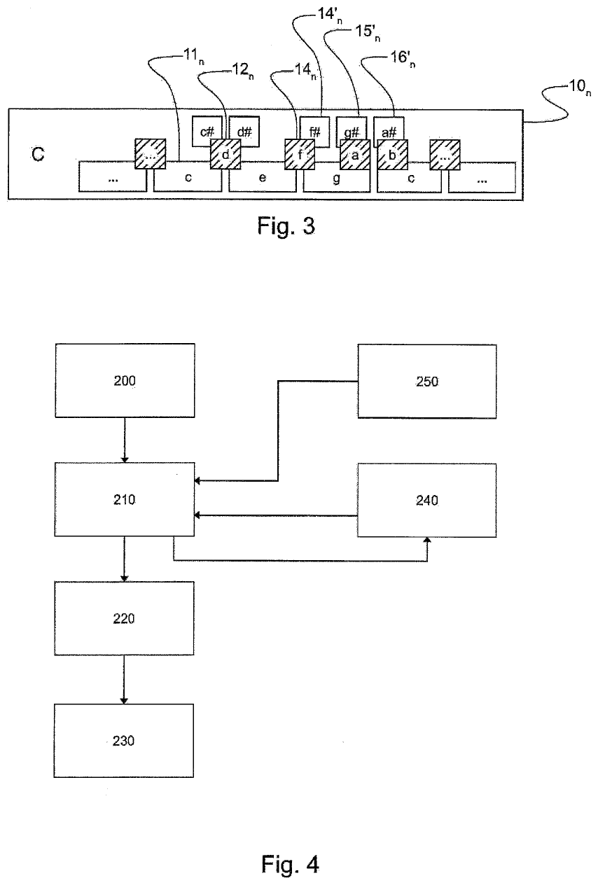

FIG. 3 shows a region of the key matrix according to a further example of embodiment of the present invention;

FIG. 4 shows a flowchart for a method for producing combined sequences of chords and tunes according to an example of embodiment of the present invention.

FIG. 1 shows a diagrammatic representation of a key matrix 1 for a user interface of a musical instrument according to an example of embodiment of the present invention. Key matrix 1 can be implemented in the form of mechanical keys, or can be displayed on a touch-sensitive touchscreen. Key matrix 1 comprises a multiplicity of activatable zones 11₁, 12₁, . . . ; 11₂, 12₂, . . . ; 11ₙ, 12ₙ, which are arranged in an orthogonal grid in columns and rows in the example of embodiment shown in FIG. 1.

A basic chord and a musical tone of the tune is associated with each zone 11₁, 12₁, . . . ; 11₂, 12₂, . . . ; 11ₙ, 12ₙ. When a zone 11₁, 12₁, . . . ; 11₂, 12₂, . . . ; 11ₙ, 12ₙ is activated, a musical tone-producing command is produced, which comprises at least one basic chord note command with a pitch, which is contained in the associated basic chord, as well as a tune note command with a pitch, which corresponds to the associated musical tone of the tune. Combined sequences of chords and tunes can thus be produced by the successive activation of individual zones, for example with one finger.

FIG. 1 shows an association of basic chords and musical tones of the tune with zones 11₁, 12₁, . . . ; 11₂, 12₂, . . . ; 11ₙ, 12ₙ according to a preferred example of embodiment of the present invention. Each row of zones forms a region 10₁, 10₂, . . . ; 10ₙ, with which a basic chord is associated in each case. The association of the musical tones of the tune is selected in such a way that the same musical tone of the tune is associated with all the zones inside a column (indicated by dashed lines) of the key matrix 1. The basic chords associated with regions 10₁, 10₂, . . . ; 10ₙ are indicated in FIG. 1 in each case on the left in regions 10₁, 10₂, . . . ; 10ₙ. The musical tones of the tune associated with the columns are indicated at the lower end of key matrix 1. Basic chord C (C-major) is thus associated for example with region 104, basic chord Em (E-minor) with region 103, and basic chord B⁰ (B reduced) with region 10₁. Musical tone C of the tune is associated in each case with zones 11, 11₂, . . . , 11ₙ in the first column. The tones of the C-major scale as musical tones of the tune are each associated in ascending order with zones in the successive columns.

The example of embodiment shown in FIG. 1 is thus configured in such a way that all the basic chords are chords of the diatonic scale C-major, the chords being specific to the scale. The tonal distance of the basic chords of adjacent regions amounts in each case to a third. All the musical tones of the tune are also chords of the diatonic scale C-major, the chords also being specific to the scale. The same musical tone of the tune is associated in each case with zones inside the same column, so that the same musical tone of the tune is associated with adjacent zones of adjacent regions. Successive musical tones of the tune (from left to right) of the diatonic scale C-major are associated in ascending order with successive zones inside each region.

For easier orientation on key matrix 1, the zones are formed visually different. The zones with which a musical tone of the tune is associated, which is also contained in the associated basic chord, are represented bright. Zones with which a musical tone of the tune is associated, which is not contained in the basic chord, are represented dark. It is also conceivable that in each region the zone, with which the tonic tone of the basic chord associated with the region is associated as the musical tone of the tune, has a further distinguishable visual formation. The visual formation for distinguishing between the zones is not limited to the distinction shown in FIG. 1. For easier orientation on key matrix 1, the zones can also be formed visually distinguishable by the fact that they have a different size colour or shape, or are characterised by symbols.

FIG. 2 shows regions 103 and 104 as a detail of key matrix 1 from FIG. 1. For the sake of clarity, the musical tones of the tune each associated with the zones are indicated on the zones. Notes are shown adjacent to each zone, which can be contained in a musical tone-producing command when the respective zones are activated. Notes which are contained in the basic chord note command are represented dark. Notes which are contained in the tune note command are represented bright.

As can be seen, the basic chord note commands of all the zones of region 103 correspond to tones of associated basic chord E-minor, i.e. tones e, g and h. The basic chord note commands of all the zones of region 104 correspond to tones of associated basic chord C-major, i.e. c, e and g.

Furthermore, according to the example of embodiment shown in FIG. 2, the pitch of the tune note command is fixed for each zone, in such a way that it lies above the pitch of all the basic chord note commands. The tonal distance between the musical tone of the tune and the closest basic chord note is always greater than a major second, in order to prevent note combinations within the respective musical tone-producing commands which could be perceived as dissonant. Alternatively, the minimum distance between a musical tone of the tune and the closest basic chord note can be selected such that it is greater than a minor second.

In order not to produce too great a tonal separation between the musical tone of the tune and the tones of the basic chord, the basic chord notes are also selected according to the example of embodiment shown in FIG. 2 in such a way that the tonal distance between a musical tone of the tune and the closest basic chord note is smaller than a fifth.

In the example of embodiment shown in FIG. 2, the musical tone-producing commands each comprise two basic chord note commands. As is indicated for the last zones at the left-hand end of regions 103, 104 with notes represented with a dashed line, more than two basic chord note commands can also be provided for a fuller sound. Furthermore, in the example of embodiment shown in FIG. 2, the basic chord notes are layered in such a way that they lie as close beside one another as possible. It is however also possible to select the basic chord notes in greater tonal distances and to distribute the latter over a plurality of octaves, or also to repeatedly assign basic chord notes in different octaves. It is also possible to associate the zones with basic chord note commands with a pitch which lies above the pitch of the musical tone of the tune.

With the example of embodiment of the user interface represented in FIG. 1 and FIG. 2, in particular with the association of the basic chords in third steps and the association of musical tones of the tune in columns in ascending order, it is particularly easy for a user even with no musical knowledge at all to produce tonally particularly pleasing combined chord and tune sequences intuitively by the simplest conceivable movements within key matrix 1.

If the user successively activates adjacent zones within the same region, for example by moving his finger on the user interface shown in FIG. 1 in the horizontal direction along a region, the basic chord remains unchanged and only the melodic character of the sound produced by the musical tone-producing commands changes. The user is thus in a position to play a tune via a fixed basic chord.

If, on the other hand, the user moves his finger on the user interface shown in FIG. 1 in the vertical direction along a column, the musical tone of the tune remains stable and the basic chord is changed. The musical tone of the tune acts as a harmonic bridge, which connects successive basic chords with one another. By the third layering of the basic chords of successive regions, chord changes are produced by the movement along a column, which are particularly expressive on account of the successive changes between major and minor basic chords. By the third layering of the basic chords, the basic chords of adjacent regions also exhibit a high degree of tonal harmony, so that the changes of harmony, which arise with a movement from one region into the adjacent region, sound particularly smooth and melodically reproducible. Combined sequences of chords and tunes can thus be played with just one finger, by the fact that a plurality of zones, in particular zones adjacent to one another, are successively activated. The user interface is thus very user-friendly and enables the playing of combined sequences of chords and tunes without particular musical knowledge.

Furthermore, with the configuration of the user interface shown in FIG. 1, it is possible to convert pure major and minor bass chords into their suspensive chords and vice versa. By a movement of the finger within a region in the horizontal direction, sound sequences are produced by the combination of the associated basic chord notes and musical tones of the tune, which alternatingly correspond to a relaxed pure and a suspensive modulation of the associated basic chord. For example, the musical tone-producing commands, which are produced with a successive activation of zones 11₄, 12₄, 13₄, 14₄ in region 10₄, correspond harmonically to chords C, C₄, C, C₆.

The shown change between suspensive and relaxed sounds with the production of combined sequences of chords and tunes is further supported and facilitated by the visual formation of the zones represented in FIG. 1 and FIG. 2. By reason of the visual formation, the user is intuitively put in a position, without theoretical musical knowledge, to distinguish between tense sounding and relaxed sounding combinations of chords and musical tones of the tune: the relaxed sounding tone combinations arise through the activation of zones represented bright, with which a tone is associated as a musical tone of the tune, which is also contained in the associated basic chord. The zones represented dark comprise an association of basic chord note commands and tune note commands, which have a suspensive sound character. The user interface thus permits a simple change between tense and relaxed acting combinations of chord tones and musical tones of the tune, without requiring corresponding musical knowledge.

As has already been mentioned above, the present invention is not restricted to the fact that the musical tones of the tune associated with the zones arise from the same audio material as the basic chords associated with the regions. FIG. 3 shows a diagrammatic representation of a region 10ₙ according to a further example of embodiment of the present invention, in which the musical tones of the tune, which are associated with the zones in region 10ₙ, form a chromatic scale, whilst the basic chord associated with the region is a chord of the diatonic scale C-major, the chord being specific to the scale.

As shown in FIG. 3, the zones in region 10ₙ are arranged partially overlapping. Zones which are associated with a musical tone of the tune, which is contained in the basic chord associated with region 10ₙ (in the example shown in FIG. 3 C-major), are represented bright and arranged in a lowermost row in region 10ₙ. Zones which are associated with a musical tone of the tune, which is not contained in the basic chord associated with the region, but in the diatonic scale belonging to the basic chord, are represented dark and in contrast with the bright zones are displaced upwards. Region 10ₙ further contained zones which are associated with a musical tone of the tune, which is not contained in the diatonic scale belonging to the basic chord. These zones 14′ₙ, 15′ₙ, 16′ₙ in contrast with the dark zones are arranged displaced upwards.

The arrangement and visual representation of the zones is selected in such a way that zones are arranged according to increasing tonal tension between basic chord and musical tone of the tune, so that the increase and reduction of the tonal tension in the production of combined sequences of chords and tunes can be implemented intuitively by the user.

FIG. 4 represents diagrammatically a flowchart of a method for producing combined sequences of chords and tunes according to an example of embodiment of the present invention. The method represented in FIG. 4 can be carried out on a computing unit such as a microcomputer, which is contained in a digital musical instrument with the user interface described above or, as a computer-implemented method, when the user interface is integrated in a virtual musical instrument, which is installed on a digital user device such as a smartphone or a tablet and is executed there.

The activation of a zone of the user interface takes place in step 200. The user interface produces an input signal, which contains information as to which zone and region of the key matrix has been activated. The input signal can optionally comprise further information such as the strike force when activating the zone, information concerning gestures performed at the user interface in the case of an implementation on a touchscreen and suchlike.

On the basis of the input signal received in step 200, a musical tone-producing command is produced in step 210. The production of the musical tone-producing command can for example take place by loading previously stored musical tone-producing commands, which are associated with the activated zone. Alternatively, the musical tone-producing command can be calculated in real time on the basis of the information contained in the input signal.

In order to guarantee optimum tonal voice leading, which can be ensured by a corresponding advantageous selection of the pitches of the base chord note commands and the tune note command, the musical tone-producing commands produced in step 210 are stored in a memory 240. When a musical tone-producing signal is calculated, the previously produced musical tone-producing commands can be retrieved from memory 240. Thus, the production of a musical tone-producing command can take place not only on the basis of the input carried out via the user interface in step 200, but also in dependence on previously produced musical tone-producing commands.

For the production of musical tone-producing commands, account can also be taken of further information or control signals, which are represented in FIG. 4 diagrammatically with the reference number 250. This information or these control signals comprise for example voice leading rules for the determination of the pitches of the basic chord and tune note commands, definitions of pitch ranges, within which basic chord notes, base notes or notes of the musical tone of the tune must lie, stipulations concerning tonal minimum distances and maximum distances between basic chords and musical tones of the tune, information concerning sound colours, sound intensities and/or, as the case may be, MIDI channels of bass, bass chord and tune note commands and suchlike.

On the basis of the musical tone-producing command thus produced, an audio signal corresponding to the musical tone-producing command is produced in a further step 220. This can take place for example by the fact that one or more previously stored audio samples are loaded from a storage medium, or that audio signals with pitches corresponding to the musical tone-producing command are calculated or synthesised in real time.

In a subsequent step 230, the audio signal produced in step 220 is outputted via an audio output interface. The audio output interface can be a cable-bound, wireless or other communication interface, such as for example a jack bush, a Bluetooth connection or a data network connection such as an Internet connection, via which the audio signal is relayed to a sound generation device. The audio output interface can also be formed by a loudspeaker or headphones, via which a direct sound reproduction of the audio signal takes place.

1. A user interface for a musical instrument, in particular an electronic or virtual musical instrument, for playing combined chord and tune sequences, comprising:
a key matrix (1) with a plurality of zones (11₁, 12₁, . . . ; 11₂, 12₂, . . . ; 11ₙ, 12ₙ, . . . ) which are arranged in columns and rows,
wherein each row of activatable zones (11₁, 12₁, . . . ; 11₂, 12₂, . . . ; 11ₙ, 12ₙ, . . . ) forms a region (10₁, 10₂, . . . ),
wherein each region (10₁, 10₂, . . . ) is associated with a basic chord, which is preferably a chord of a scale, preferably a diatonic scale, the chord being specific to the scale,
wherein each zone (11₁, 12₁, . . . ; 11₂, 12₂, . . . ; 11ₙ, 12ₙ, . . . ) is associated with a musical tone, which is preferably a musical tone of a scale,
wherein the user interface is designed to produce, when a zone (11₁, 12₁, . . . ; 11₂, 12₂, . . . ; 11ₙ, 12ₙ, . . . ) in a region (10₁, 10₂) is activated, a musical tone-producing command corresponding to the activated zone (11₁, 12₁, . . . ; 11₂, 12₂, . . . ; 11ₙ, 12ₙ, . . . ) and region (10₁, 10₂, . . . ),
wherein the musical tone-producing command comprises at least one basic chord note command with a pitch which is contained in the basic chord associated with the activated region (10₁, 10₂, . . . ), and comprises a tune note command, the pitch of which corresponds to the musical tone of the activated zone (11₁, 12₁, . . . ; 11₂, 12₂, . . . ; 11ₙ, 12ₙ, . . . ).

2. The user interface according to claim 1,
wherein the basic chords, which are associated with regions (10₁, 10₂, . . . ) adjacent to one another, have a tonal distance of one third from one another.

3. The user interface according to claim 1, wherein musical tones of the tune are associated in ascending pitch with the zones (11₁, 12₁, . . . ; 11₂, 12₂, . . . ; in each region (10₁, 10₂, . . . ),
wherein the musical tones of the tune, which are associated with successive zones (11₁, 12₁, . . . ; 11₂, 12₂, . . . ; in each region (10₁, 10₂, . . . ), preferably form a scale, preferably a diatonic scale.

4. The user interface according to claim 1, wherein the same musical tone of the tune is associated with the zones (11₁, 12₁, . . . ; 11₂, 12₂, . . . ; 11ₙ, 12ₙ, . . . ) in each column of the key matrix (1).

5. The user interface according to claim 1, wherein the pitch of the at least one basic chord note command is selected for each zone (11₁, 12₁, . . . ; 11₂, 12₂, . . . ; 11ₙ, 12ₙ, . . . ), in such a way that it lies below or above the pitch of the musical note-producing command.

6. The user interface according to claim 1, wherein for each zone (11₁, 12₁, . . . ; 11₂, 12₂, . . . ; 11ₙ, 12ₙ, . . . ) the pitch of the at least one basic chord note command is selected in such a way that the tonal distance between the tune note command and the closest basic chord note command is greater than a minor second.

7. The user interface according to claim 1, wherein the musical tone-producing command includes for each zone (11₁, 12₁, . . . ; 11₂, 12₂, . . . ; 11ₙ, 12ₙ, . . . ) a bass note command, which corresponds to one of the tones of the basic chord, preferably the tonic tone of the basic chord, and has a pitch which is lower than the pitch of the remaining note commands.

8. A musical instrument, comprising a user interface according to claim 1, as well as a sound generator, which is designed, based on the musical tone-producing commands, to produce an audio signal for output via an audio output interface.

9. The musical instrument according to claim 8, comprising a touchscreen, on which the key matrix (1) can be displayed and the zones (11₁, 12₁, . . . ; 11₂, 12₂, . . . ; 11ₙ, 12ₙ, . . . ) can be activated by touch.

10. A method for producing combined chord and tune sequences using a user interface for a musical instrument for playing combined chord and tune sequences, comprising a key matrix (1) with a plurality of zones (11₁, 12₁, . . . ; 11₂, 12₂, . . . ; 11ₙ, 12ₙ, . . . ) which are arranged in columns and rows, wherein each row of activatable zones (11₁, 12₁, 11₂, 12₂, . . . ; 11ₙ, 12ₙ, . . . ) forms a region (10₁, 10₂, . . . ), wherein each region (10₁, 10₂, . . . ) is associated with a basic chord, which is preferably a chord of a scale, preferably a diatonic scale, the chord being specific to the scale, wherein each zone (11₁, 12₁, . . . ; 11₂, 12₂, . . . ; 11ₙ, 12ₙ, . . . ) is associated with a musical tone, which is preferably a musical tone of a scale, wherein the user interface is designed to produce, when a zone (11₁, 12₁, . . . ; 11₂, 12₂, . . . ; 11ₙ, 12ₙ, . . . ) in a region (10₁, 10₂) is activated, a musical tone-producing command corresponding to the activated zone (11₁, 12₁, . . . ; 11₂, 12₂, . . . ; 11ₙ, 12ₙ, . . . ) and region (10₁, 10₂, . . . ), wherein the musical tone-producing command comprises at least one basic chord note command with a pitch which is contained in the basic chord associated with the activated region (10₁, 10₂, . . . ), and comprises a tune note command, the pitch of which corresponds to the musical tone of the activated zone (11₁, 12₁, . . . ; 11₂, 12₂, . . . ; 11ₙ, 12ₙ, . . . ), preferably by using a musical instrument, comprising the following steps:
provision of the user interface;
reception of a user input when a zone (11₁, 12₁, . . . ; 11₂, 12₂, . . . ; 11ₙ, 12ₙ, . . . ) of the key matrix (1) is activated;
producing a musical tone-producing command corresponding to the activated zone (11₁, 12₁, . . . ; 11₂, 12₂, . . . ; 11ₙ, 12ₙ, . . . ).

11. The method according to claim 10, also including the following steps:
loading of previously stored audio samples from a storage medium or synthesis of an audio signal corresponding to the produced musical tone-producing command;
outputting of the audio samples or the audio signal via an audio output interface.

12. The method according to claim 10, wherein the method is constituted as a computer-implemented method and the provision of the user interface comprises the display of the key matrix (1) on a touchscreen.

13. A computer-readable storage medium which contains instructions which cause at least one processor to perform a computer-implemented method according to claim 12, when the instructions are carried out by the at least one processor.

14. A method for producing combined chord and tune sequences according to claim 10, wherein the musical instrument comprises the user interface, as well as a sound generator, which is designed, based on the musical tone-producing commands, to produce an audio signal for output via an audio output interface.

15. A method for producing combined chord and tune sequences according to claim 14, wherein the musical instrument further comprises a touchscreen, on which the key matrix (1) can be displayed and the zones (11₁, 12₁, . . . ; 11₂, 12₂, . . . ; 11ₙ, 12ₙ, . . . ) can be activated by touch.
